(19) United States
(12) Patent Application Publication
(10) Pub. No.: US 2006/0190294 A1
(43) Pub. Date: Aug. 24, 2006

(54) Medispatch: A concept for secure medical communication

(75) Inventors: James Dean Michelson, Columbia, MD (US); Steven Isidor Hirschfeld, Silver Spring, MD (US)

Correspondence Address: James Michelson, 9502 Sylvan Dell, Columbia, MD, 21045, US

(73) Assignees: James Dean Michelson, Columbia, MD (US); Steve Isidor Hirschfeld, Silver Spring, MD (US)

(21) Appl. No.: 10/906,453

(22) Filed: Feb. 21, 2005

(51) Int. Cl. G06Q 50/00

(52) U.S. Cl. 705/2

(57) ABSTRACT

Medispatch is a proposal for a service to provide an unmet medical need for secure universal communication between patients and their health care providers or facilities. The features of the service are security through encryption, authentication of the sender and receiver of information, and non-repudiation of the information. Through a simple e-mail interface, it will be possible to integrate the patient's medical record for the patient, their designated health care providers, and the pharmacies that fill their prescriptions. The provision of this service as a stand-alone service that can be easily integrated into any medical information services that already exist within a hospital, clinic, medical office, ambulatory surgery center, etc., is designed to allow such facilities to effectively outsource the administrative burden of this important mode of patient communication while maintaining security and HIPAA compliance. Built-in limitations with respect to storage of information and forwarding information from the service are designed to enhance the security of the service.

The system from the patient's viewpoint will consist of limited mail-box functionality that includes a means to receive messages and information from authorized users, a means to respond to messages, a means to contact authorized users through individualized address lists and menus, and an inability to forward messages. The last feature avoids potential liability of lack of encryption and avoids the potential for contact of non-enrolled health care facilities or providers by patients. All messages will be subject to time-limited storage, as well as storage of mail locally. The system is not intended to replace traditional e-mail services or storage and (for both security and resource reasons) is not intended as archive. All communications could be copied for local storage.

Access to the system will be on a voluntary basis, available at any time. In setting up a profile, a client would have the option to indicate a standard e-mail address to which message alerts could be sent. The administration of e-mail accounts will be centralized in a resource that has the necessary infrastructure (hardware and software) to avoid the need for a health care facility to perform administration of a potentially very large set of active and inactive accounts (e.g.—with the administrative overhead of managing constantly changing mailbox owners). In addition, central administration can assure compliance with the regulatory guidance of the Department of Health and Human Services and the Joint Commission on Accreditation of Health Care Organizations for methodology. Lastly, central administration allows healthcare facilities to focus on their core competencies and provides health care facilities with legal protection in their use of e-mail patient communication.

Adding data or reports to the system would be handled in various ways, including the use of middleware (for example XML enabled services or web based services) to permit ease of data transfer independent of local information syntax and protocols. In this role, Medispatch would function as an integrator of health related information for each patient.

The system has particular advantages for patients who have the option to designate who should receive copies of communications. An example might be a patient who is referred to a tertiary center and designates the referring physician as a recipient of all communications from the tertiary center. The referring physician could check either periodically or in response to a standard e-mail alert. With the patient's permission, any facility could inform other registered providers of some or all communications so that all relevant parties remain current and informed.

Another example is the circumstance when a patient who is a subscriber in a health plan is treated emergently at other facilities with a complex series of interventions, possible follow up at local out patient offices and then eventual return to the home health plan. All the facilities could, with the permission of the patient, send all reports to Medispatch and all would have access to the information in a timely way.

The filling of prescriptions (for medications, durable medical equipment DME-, etc.) is a distinct service offered by the system. For the provider, a prescription writer for medications and DME is available on-line, along with the automatic presentment of the appropriate certification of need forms. For the pharmacy, or DME supplier, the system provides rapid automatic notification of the prescription, a legible prescription, as well as access to relevant medical information (e.g. allergies), validation of the prescription, and whatever medical necessity forms have been submitted by the provider. The advantages for the patient is rapid filling of their prescription, fewer issues of illegible handwriting that can cause medical errors, and not having to worry about losing the paper prescription.

The proposed system will use encrypted e-mail as its method because it is inexpensive and easy to use for all parties. There is no need for specialized software or training because the security will be located on the servers.

The system architecture is designed to provide a secure e-mail functionality that is easily implemented by health care practitioners. It is not intended to provide the range of functionality needed for a complete electronic medical record (EMR) system. The system is a secure (all users authenticated and authorized, all communications encrypted, all transactions-not content-logged with 100% audit capabilities) enhanced e-mail system, without mail forwarding capability (to limit liability). The audit, security, and authentication capabilities would be sufficient for the system to be credentialed as HIPAA compliant. Users can download any information to their own computers to utilize as they wish, at which point it is not controlled, tracked, or audited by the system.

For purposes of reliability, the servers used would be redundant. For purposes of security and auditing, the system would have 2 different types of servers. One type would contain the actual health information, while the second would contain the transaction logs needed for auditing, etc.

There would be routing/automated response capabilities directly linked to the patient's e-mail. Examples of this include responding to requests for medical records to be forwarded to the patient's insurance company, routing of prescriptions to a pharmacy, and routing of requests by patients to the correct clinical department (appointments, Rx renewals, etc.). Furthermore, transaction records could be downloadable by the provider to put in a patient's chart, with multiple report types available to the health care provider.

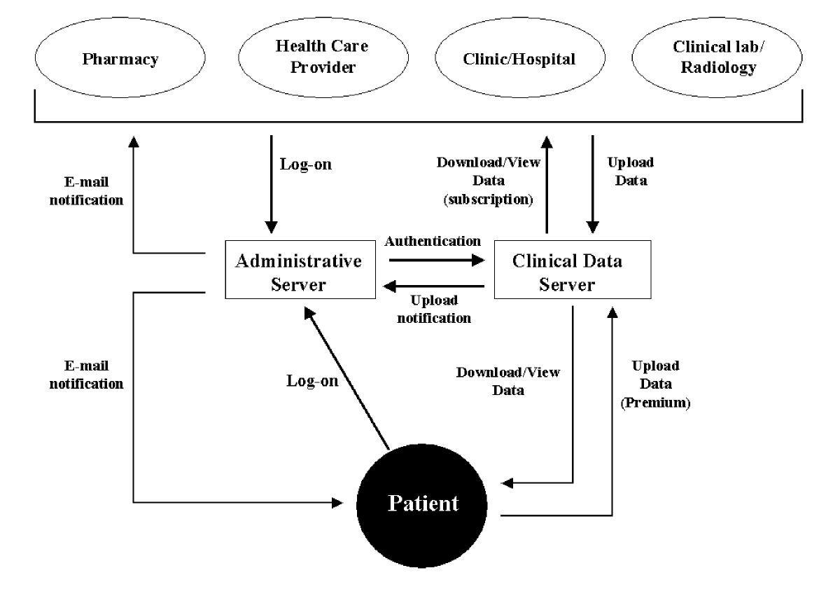

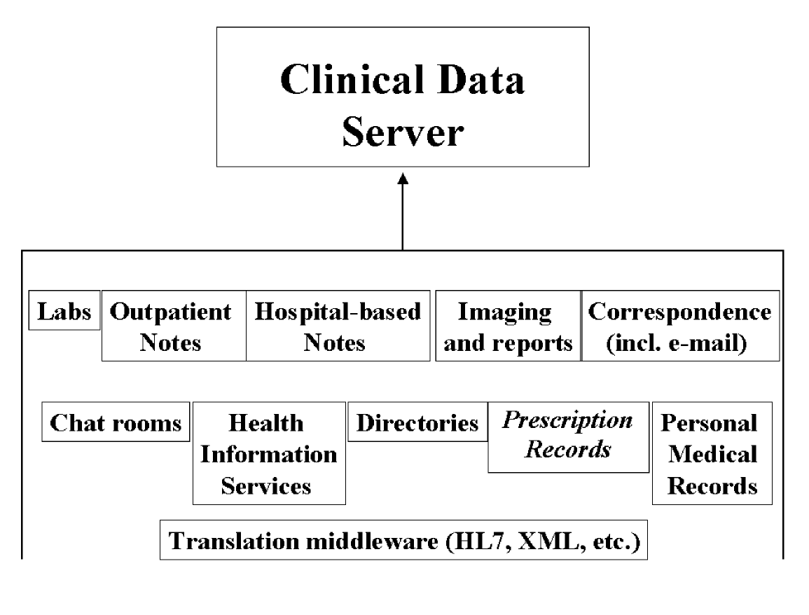

See FIG. 1 for a diagram of the overall architecture.

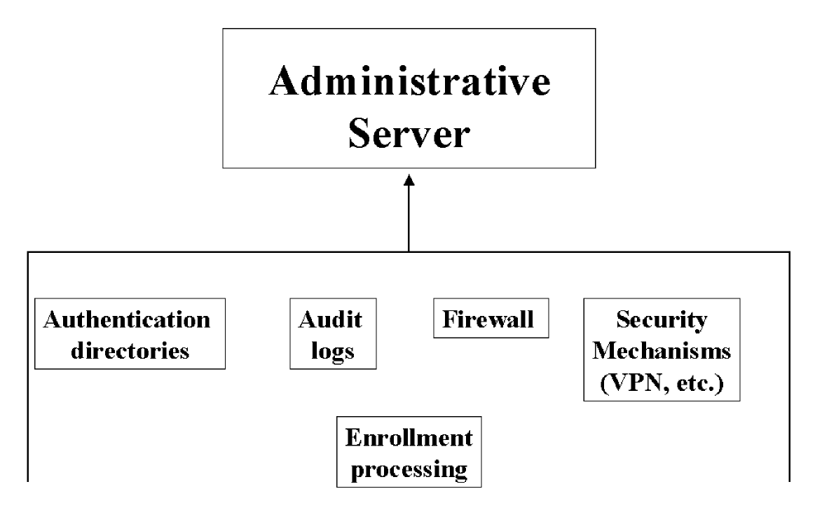

FIGS. 2 & 3 outline the specific functional aspects of the administrative and clinical servers.

Role-related activities in the system:

Patient

Register

Retrieve non-specific information including provider directory

Send messages to providers

Access to logs for personal records

Post to chat room

Retrieve messages

Retrieve personal records for viewing/local storage

Provider/Clinic

Register

View non-specific information

Upload documents

Use prescription writer to send prescriptions to pharmacy/DME supplier

Retrieve documents (when permitted by patient)

Post to chat room

Retrieve messages

Communicate with patients and other providers

Pharmacy/DME supplier

Register View and download pending prescriptions

View and download relevant medical information

Download medical necessity forms

Upload notification of filled prescription

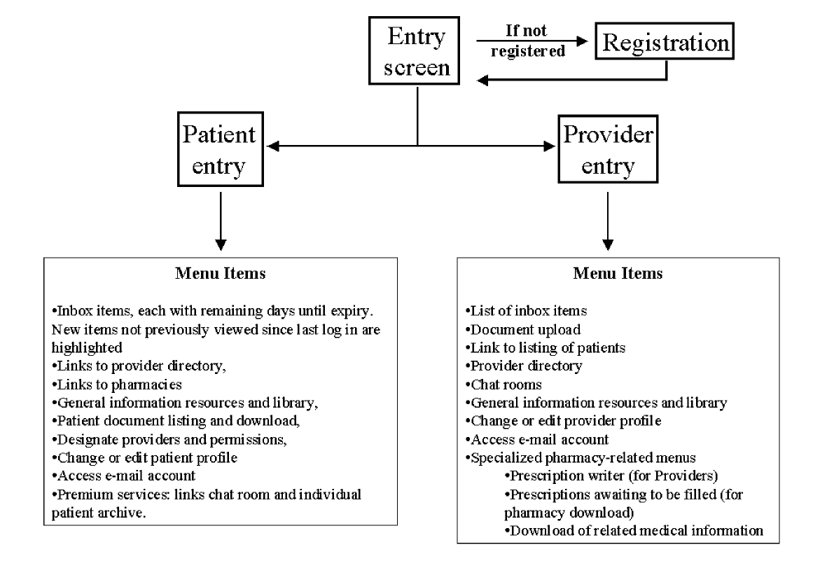

Screens (See FIG. 4 for overview of work-flow through screens)

1. Welcome Screen: Service Logo with list of features and Log In (User Name and Password) or Options to Register as Patient or Provider.

2. Registration as Patient: Required items: Name, user name, password Optional items: e-mail address for announcements, opportunity for subscribing to Premium services, opportunity to set up profile based on interests, geographic location and health needs.

3. Registration as Provider: Required items: Name, user name, password, billing address, office or clinic addresses (to link to maps and geographic databases), preferred patient contact information, specialty, health care plans, affiliated hospitals The provider will also select service/payment plan and download software for document uploading (if necessary).

4. Registered Patient—Menu screen—with list of color and icon coded inbox items each with remaining days until expiry. New items not previously viewed since last log in are highlighted. Links to provider directory, general information resources and library, patient document listing and download, designate providers and permissions, change or edit patient profile. Premium service would have additional links to chat room and individual patient archive.

5. Provider Directory—Search screen with fields such as name, geographic location, specialty, insurance plan, plus browse functions

6. Registered Provider—Menu screen with list of inbox items, highlighting with color and symbol coding, document upload, link to listing of patients, provider directory, chat rooms, general information resources and library, change or edit provider profile

7. Chat room directory

8. Library—General information—links, other non-specific resources Each screen will have a link to online help and technical support.

Uploading: One key component of the Medispatch system is its function as an integrator of patient specific information from multiple disparate sources. Implementation would be through middleware for disparate systems.

A second purpose of the service would be to facilitate communication between the physician and patient. An example would be having all communications from a single health care facility or system (such as laboratory test results, imaging studies, and care instructions) uploaded in a standardized format. Whether a single health care system or disparate providers supply the data, the type of communication would be coded by color or symbol (icon) for identification. The patient has the opportunity to copy or print the results and archive as desired. The patient has the additional option of replying to the results with a question or comment to the appropriate care provider. The care provider has the option of adding an explanatory message to the results and has the additional advantage of being able to view all the recent results from a patient to provide more informed care.

The majority of physician reports are currently in electronic form, either typed into a computer in the office or uploaded into the office computer by the transcription service. All other health information (e.g.—lab reports, radiology reports and images) is primarily generated in electronic form available to the physician. In either case, the data documents (with the appropriate identifiers) are uploaded to the secure e-mail system, where it will then be available to the patient. If necessary, an upload utility can be distributed to the physician's office during registration that will enable a simple upload mechanism. The upload utility would allow mapping or tagging of fields from the health care provider data to a format that would allow consistent display in all Medispatch communications. If the upload utility is not used, then either an image of the data can be displayed or the mapping of fields could be done at each session. The upload utility would allow batching and automation to give the most flexibility to transfer data to patients and other health care providers.

The patient will be notified at each logon or by e-mail that new health information is available. E-mail notification that new information is available will not be sent unless the patient chooses to do so (opt-in), as it would not be HIPAA compliant. The format of the information would vary with the type of document: text files for reports, image files for radiology images, etc.

Patients would have the option to upload information to complete a record and produce a composite report. Patient loaded information would be through standardized forms (not the upload utility for practitioners) and specifically identified as being patient (as opposed to laboratory or health care facility) originated.

Security: Of critical import is that the system be secure, meaning it has authentication, encryption, non-repudiation, and conforms to the Health Insurance Portability and Accountability Act guidelines that became effective on Apr. 14, 2003. This is obtainable using newer methods of encryption through a standard interface and log on procedure.

All results and communications would be secure, time limited, and universally accessible. The retention of all data is time limited, with a default of 21 days. This would be adjustable only by the patient, up to a maximum of 60 days. There is a separate retention-timer for each document. The patient would get a warning when any document is approaching the end of document retention, so they would have the opportunity to download the document for local storage if they wished. This service is not intended to provide a persistent medical record, and explicitly cannot be relied upon to provide a complete medical history for the patient or health care provider. Given this understanding, as a premium service to the patient, the health information could be retained for longer periods of time. However, its functionality could be an extension of a pre-existing EMR, so as to provide a more “integrated” medical record that was conveniently available to the patient.

The automated distribution of the patients records (e.g. to other physicians) would be decided by patient, using information provided by the patient about the recipients (email address, etc.).

1. There would be a permission screen to allow the sending of information. If the e-mail address of physician not known by patient, then not displayed.

2. This would allow consultations to other physicians to be initiated by either the physician or the patient

3. In order to maintain security, the recipient of the information would have to be registered in the system, so that all transferal of information was secure. In the event that the indicated recipient is a non-participant, an e-mail would be sent indicating the pending provision of patient-related information and the requirement to enroll in Medispatch to access the information.

What is claimed is:

1. The system described provides secure communication, data storage, and data integration amongst all the participants in the health-care system (including but not limited to patients, physicians, other care-givers, pharmacies, durable medical equipment suppliers).

2. The system relies on standard internet protocols and is accessible from all networked computers.

3. All communications between the participants and the system are by secure, encrypted communications protocols.

4. Through a simple interface, the patient's medical record can be integrated for the patient, their designated health care providers, and the various suppliers of health-care goods and services (e.g.—pharmacies).

5. This service is a stand-alone service that can be easily integrated into any medical information services that exist within a hospital, clinic, medical office, ambulatory surgery center, etc.

6. This service allows healthcare facilities to outsource the administrative burden of this important mode of individualized patient communication while maintaining security and HIPAA compliance.

7. The sources of stored information include (but are not limited to) health-care-provider generated medical records, prescriptions, lab and radiology reports, imaging, insurance information, and patient generated record.

8. The system provides a secure centralized repository of information for the patient, who has control over the uses of such information. At his/her request, such information (or any portion designated) can be forwarded to designated participants in their health care.

9. The centralized storage of information and messaging is time-limited, unless otherwise arranged by the patient. All communications could be copied for local storage by the patient. This local storage functionality is available to the health-care provider as well, if permitted by the patient.

10. Data storage, transmission, communications, and other information management functions are secure, confidential, and fully compliant with all relevant regulations (e.g. Health Insurance Portability and Accountability Act).

11. The transactions of the system are 100% audited, using a monitoring system that is distinct from the data storage system. There is no auditing of the data once it has been locally stored by the patient, health-care provider, etc.

12. At the request of the patient, the health information can be processed by digital rights management (DRM) software to limit the subsequent distribution of the information.

13. The system, from the patient's viewpoint, will consist of limited mail-box functionality that includes a means to receive messages and information from authorized providers, a means to respond to messages, a means to contact authorized providers through individualized address lists and menus, and an inability to forward messages (except to authorized providers or if first copied to local storage and forwarded from there). The last feature avoids potential liability of lack of encryption and avoids the potential for contact of non-enrolled health care facilities or providers by patients.

14. The system, from the provider's viewpoint, will consist of document/image/data upload capability, and mailbox functionality similar to that of patients (including means to receive messages and information from authorized providers, a means to respond to messages, a means to contact authorized providers through individualized address lists and menus, and an inability to forward messages except to authorized providers unless first copied to local storage and forwarded from there)
The system prevent providers from forwarding information unless specifically authorized by the patient.

15. The system provides the means for initiating consultations by other providers registered in the system, when authorized by the patient.

16. Communications will be coded or tagged according to content.

17. Providers will be able to track the status of patient care actions that they initiated, such as filling of prescriptions, completion of consultations.
